(19) United States
(12) Patent Application Publication
(10) Pub. No.: US 2023/0266159 A1
(43) Pub. Date: Aug. 24, 2023

(54) Method for Monitoring at Least One Working Machine Driven by a Rotating Machine

(71) Applicant: KSB SE & Co. KGaA, Frankenthal (DE)

(72) Inventors: Christian RUESCHOFF, Frankenthal (DE); Maximilian HAUSKE, Mannheim (DE)

(21) Appl. No.: 18/012,725

(22) PCT Filed: Jun. 23, 2021
(86) PCT No.: PCT/EP2021/067129

§ 371 Date: Dec. 23, 2022

(30) Foreign Application Priority Data
Jun. 24, 2020 (DE) 10 2020 116 636.2

(51) Int. Cl. G01H 1/00; G01M 13/028

(52) U.S. Cl. CPC G01H 1/003; G01M 13/028

(57) ABSTRACT

A method and system for monitoring at least one working machine driven by a rotating machine includes detecting at least one item of detection information in the working machine which is specific to an acceleration in the working machine, transmitting the detection information via a network to a central processing device, and processing the transmitted detection information to determine rotational speed information which is specific to a rotational speed of the rotating machine.

### CROSS REFERENCE TO RELATED APPLICATION

This application claims priority under 35 U.S.C. § 119 from German Patent Application No. 10 2020 116 636.2, filed Jun. 24, 2020, the entire disclosure of which is herein expressly incorporated by reference.

### BACKGROUND AND SUMMARY OF THE INVENTION

The present invention relates to a method for monitoring at least one working machine driven by a rotating machine. The invention further relates to a system and a computer program for such monitoring.

In the case of working machines such as pumps, monitoring of the state of the working machine and, in particular, the rotating or electric machine which drives the working machine is highly relevant for guaranteeing functionality. It is known from the prior art that diagnostic devices can be used in the working machine, said diagnostic devices detecting a measured quantity on the working machine and enabling an assessment of the state and specifically a rotational speed of the working machine through an evaluation of the detected measured values.

However, the evaluation according to conventional methods can often be performed only imprecisely or with high technical complexity, since, for example, a high number of detected measured values are required. In addition, conventional methods for determining the rotational speed have the disadvantage that they are based either on a direct evaluation of electrical measured quantities of the rotating machine or, in the case of rotational-speed-regulated working machines, cannot be reliably used.

One object of the present invention is therefore to eliminate at least partially the disadvantages described above. In particular, one object of the present invention is to propose an improved solution for monitoring working machines.

The above object is achieved by a method, a system and a computer program having the features in the independent claims. Further features and details of the invention are set out in the respective subclaims, the description and the drawings. Features and details which are described in connection with the method according to the invention obviously also apply in connection with the system according to the invention and the computer program according to the invention, and in each case vice versa, so that reference is or can always be made reciprocally in relation to the disclosure for the individual inventive aspects.

The object is achieved, in particular, by a method for monitoring at least one working machine, whereby the working machine is preferably driven by a rotating, in particular electric, machine. The working machine can be designed e.g. as a pump or specifically as a centrifugal pump in which the rotating machine drives a pump shaft.

In the method according to the invention, it can be provided that at least one of the following steps is carried out, preferably successively in the indicated sequence or in any sequence, wherein individual and/or all steps can also be carried out repeatedly:
detecting at least one item of detection information in the working machine, wherein the detection information can be specific to an acceleration, in particular for a mechanical oscillation and/or speed change and/or deflection (and/or for a rotational speed of the rotating machine) in the working machine, wherein the detection is preferably performed by a monitoring device on the working machine,
transmitting the detection information via a network to a central processing device, wherein, in particular, a transmission device of the monitoring device transmits the detection information to the network for this purpose and the central processing device receives the detection information from the transmission device,
performing a processing of the detection information, in particular the transmitted detection information, preferably by means of the processing device in order to determine rotational speed information for the monitoring which is specific to a rotational speed of the rotating machine and/or the working machine.

The processing of the detection information previously transmitted to the central processing device offers the advantage that the processing in order to determine the rotational speed information can be performed centrally outside the location of the working machine. A monitoring device for detecting the detection information can therefore be designed as technically less complex and can have a lower energy consumption. In addition, the method according to the invention can enable the monitoring in a particularly reliable manner by means of the processing, wherein the processing is designed, in particular, as an oscillation analysis of the detection information for this purpose.

Where appropriate, a monitoring device such as a diagnostic device can be used directly on the working machine in order to detect the detection information and transmit the detection information. The diagnostic device can be used primarily for detection, so that the processing is carried out at least predominantly by the central processing device and, where appropriate, an only partial oscillation analysis of the detection information by the monitoring device can also even be dispensed with. It is thus possible for the processing to be performed centrally by the processing device in order to minimize the technical complexity for the monitoring device. It is further possible for the detection information to be distinguished from an electrical measured quantity and/or control quantity of the rotating, in particular electric, machine, so that the monitoring and, in particular, the determination of the rotational speed information can be performed without the use of electrical measured quantities or parameters of the regulation of the rotating machine. Access to the rotating machine or to the regulation of the rotating machine can thus be dispensed with in order to carry out the method according to the invention.

The working machine can be designed e.g. as a pump arrangement, such as a centrifugal pump arrangement. The working machine can further be driven by an electric and/or rotating machine, such as an asynchronous motor. The asynchronous motor can be designed for this purpose as an unregulated asynchronous machine (i.e., for example, running on the mains supply) or as a rotational-speed-regulated asynchronous machine. In the case of a rotational-speed-regulated asynchronous machine, it can be provided that no access is available to regulation information (such as an electrical measurement and/or adjustment and/or regulation quantity of the rotating machine) by the monitoring device or for the monitoring device. It can essentially be provided according to the invention that a determination of the rotational speed directly on the rotating machine is prevented. Physical access to the rotating machine, for example, and/or an evaluation of an electrical measured quantity of the rotating machine can thus be prevented. It is therefore necessary to determine the rotational speed indirectly, e.g. via an evaluation of the resulting mechanical oscillations on the working machine. The oscillations can be detected e.g. by at least one oscillation sensor in order to enable the evaluation.

The monitoring device can have at least one oscillation sensor in order to detect (mechanical) oscillations. The at least one oscillation sensor can be designed to detect accelerations in at least one or at least two or at least three or precisely three directions (in particular orthogonal to one another and/or identical) on the working machine. It is possible for the resulting detection information to be represented by relatively small data (i.e. with a reduced data volume), so that a transmission of the data via a network, such as the Internet, and therefore central processing are possible. In order to obtain the data with a reduced data volume, the detection information can be obtained from a measurement of the at least one oscillation sensor with a short measurement duration. The energy consumption of the monitoring device can therefore also be reduced and a technically complex processing directly by the monitoring device can be dispensed with. The method according to the invention or the monitoring system according to the invention therefore also enables a particularly reliable and precise digitized detection and/or evaluation of pump parameters such as the rotational speed.

It is possible for the monitoring device to have at least one or at least two or at least three or precisely three acceleration sensors for detecting (mechanical) oscillations in order to detect accelerations in each case in the same (measurement) direction on the working machine. A redundant detection of the oscillations by the monitoring device, for example, can thus be possible. Any number of different or identical measurement directions at any number of spatial measurement points (the spatial positions of the acceleration sensors) can essentially be provided. The measurement is preferably performed simultaneously by the acceleration sensors. Alternatively or additionally, the monitoring device can have at least one or at least two or at least three or precisely three acceleration sensors for detecting the (mechanical) oscillations in order to detect the accelerations in different and, in particular, orthogonal, directions on the working machine. The respective oscillation sensor can further have at least one of the acceleration sensors.

The detection information can be designed as oscillation information, for example as measured values which result from a measurement of mechanical oscillations and/or accelerations on the working device. This means that the detection information can comprise at least one item of information relating to an oscillation of the working machine and/or the rotating machine. The detection information can specifically be a short-term recording of oscillation data which is performed, for example, in at least one or two or three dimensions. At least one oscillation sensor which measures the oscillations on the working machine and/or the rotating machine can be used accordingly for detecting the detection information. The detection information can be designed—in general terms—as a signal with a repeating pattern, wherein the frequency of these repetitions can be evaluated by means of a frequency analysis. A Fourier analysis, for example, can be used as a frequency analysis for this purpose in order to thus determine which frequency components are present at what strength—i.e. at what amplitude—in the detection information. The detection information is thus divided into a fundamental frequency and into further frequencies. The further frequencies can correspond to integral multiples of the fundamental frequency and can therefore correspond to the harmonics of the fundamental oscillation. The fundamental frequency can represent the relevant parameter for the monitoring, from which e.g. the rotational speed can be determined.

The frequency analysis (particularly in the form of a Fourier transform) of a short-term recording of oscillation data of a rotating machine can reveal increased manifestations in the harmonics of the rotational frequency of the machine. A smart processing of this information can thus be used according to the invention to obtain a robust rotational speed estimation which offers better results in terms of precision and stability despite short-term data. This additionally offers the advantage that short-term measurements are already sufficient for detecting the detection information and the detection information can be transmitted during the transmission by means of data having a small size and/or volume. In this way, the subsequent processing can also be performed outside the monitoring device, e.g. centrally in a processing device, i.e., for example, can be executed in the cloud. In addition, the described procedure enables the estimation of the rotational speed to be carried out for working machines also, such as rotational-speed-regulated pumps. The energy consumption in the oscillation sensor can further be reduced since the detection of the detection information is less complex and the monitoring device can therefore also be battery-operated for a longer period.

The invention can be based on the consideration that the determination of the fundamental frequency of the detection information is possible in a more robust and reliable manner if it is performed while additionally taking account of the harmonics. The determination of the rotational speed information is thus based not only on the identification of one frequency, but is additionally supported by the determination of further frequencies. This can further have the result that an unwanted instability of the processing is avoided. An unstable frequency determination can occur according to conventional solutions e.g. if only one frequency is identified in the frequency spectrum on the basis of a peak with the best signal-to-noise ratio. However, a plurality of frequencies of the harmonics can be used according to the invention for the frequency determination. The use of normalized peak values for calculating a sum spectrum can be particularly advantageous for this purpose, as will be described in detail below.

It can be possible in a method according to the invention for rotational speed information to be determined as a result of the processing, specifically providing information relating to a rotational speed (or rotational frequency) of the working machine and, in particular, the rotating machine. The rotational speed information can comprise, in terms of values, e.g. the fundamental frequency or rotational frequency in hertz, or the rotational speed in rotations per time unit, in particular per minute. This information can be further processed in order to determine e.g. a state of the working machine. The rotational speed information indicates e.g. a malfunction of the working machine. Where appropriate, the rotational speed information can also be used to perform an operating point estimation for the working machine. Depending on the determined rotational speed information, an action can optionally be initiated, e.g. a corresponding error message to a user or an automatic shutdown of the working machine if the malfunction has been detected.

It is further conceivable for the detection to be performed by at least or precisely one oscillation sensor on the working machine, in particular for oscillations in one or two or three directions orthogonal to one another (and/or identical) in order to determine the detection information preferably in the form of one-dimensional or two-dimensional or three-dimensional acceleration values. The oscillation sensor has, for example, one to three (or more) acceleration sensors for this purpose which are aligned in such a way that they measure accelerations in the (one or two or) three different (or identical) directions. The oscillations can thus be reliably detected on the working machine.

It can be advantageous if the network is designed according to the invention at least partially as a mobile radio network and/or Internet and/or WLAN (Wireless Local Area Network) and/or Bluetooth network and/or the like, possibly also as a combination thereof, wherein the detection information is preferably detected on a multiplicity of working machines at different locations and is transmitted to the processing device for central processing. The central processing device can thus essentially have a data connection to the multiplicity of working machines in order to receive the detection information in each case. The processing can also be performed in a cloud-based manner. A technically efficient central processing facility is thus provided.

It can further be provided according to the invention that the processing is performed as an oscillation analysis, in particular in order to determine the rotational speed information on the basis of a fundamental oscillation and further harmonics of the detection information, preferably in order to perform an estimation of the rotational speed. The frequency of the fundamental oscillation can specifically indicate the rotational speed here. The harmonics can additionally be used to improve the determination of the fundamental frequency and/or the estimation of the rotational speed.

It is further conceivable for the fundamental oscillation to be determined (i.e. identified) during the processing through an evaluation of the harmonics, in particular in order to estimate the rotational speed therefrom (i.e. from the determined fundamental oscillation). The harmonics have a frequency which occurs in a fixed ratio to the fundamental frequency. It is therefore possible to assess the fundamental frequency by evaluating the harmonics.

A further advantage according to the invention is achievable if the following steps are carried out during the processing in order to determine the rotational speed information:
performing a frequency analysis of the detection information in order to determine a frequency spectrum of the detection information,
performing an identification of a plurality of frequencies in the frequency spectrum, wherein the frequencies are preferably assigned to a fundamental oscillation and/or at least a predefined number of harmonics of the detection information,
performing a calculation on the basis of the identified frequencies, wherein the calculation can be parameterized by the predefined number of harmonics.

If the detection information has values for different dimensions, e.g. for different directions x, y and z orthogonal to one another in the oscillations, a frequency analysis can be carried out in each case for each of these dimensions. A frequency spectrum can be obtained accordingly for each frequency analysis, but said frequency spectra can optionally be combined with one another, e.g. combined through accumulation to form one frequency spectrum. In this way, an additional reduction of noise is also possible. The calculation can be performed by comparing the detected harmonics and the detected fundamental oscillation with one another in order to obtain information relating to the rotational speed and/or to identify the frequency of the fundamental oscillation (fundamental frequency).

It is optionally conceivable for the performance of the identification of (a plurality of) frequencies to comprise the following steps:
identifying peak values in the frequency spectrum in order to identify the frequencies at the peak values, wherein, in particular, the identified peak values are assigned to those frequencies which correspond to a harmonic of a fundamental oscillation and/or to the fundamental oscillation,
normalizing the identified peak values in the frequency spectrum in order to perform the subsequent calculation on the basis of the normalized peak values.

A normalization can be understood here to mean that the detected peak values are set to the same value (same amplitude) so that the amplitude of the respective peak values influences the detection but not the subsequent calculation. The peak values are detected as such, for example, only if they meet specific requirements, e.g. form maxima and/or lie above a noise component of the detection information. The frequencies such as the harmonics and/or the fundamental oscillation can be assumed in the detection, for example, at the position of the detected peak values. The peak values can also be detected e.g. by means of a threshold value or the like for this purpose.

In a further option, it can be provided that the (subsequent) calculation comprises the formation of a sum spectrum in which an addition of the identified frequencies, in particular the normalized peak values, is performed in a weighted manner. This represents a reliable possibility for determining (i.e. identifying) the rotational speed information and, in particular, the fundamental frequency, taking account of the harmonics. This can further also serve as a noise-suppressing measure in order to improve the reliability of the frequency determination.

It is further conceivable according to the invention for a frequency determination to be performed on the basis of the sum spectrum in order to determine the rotational speed information, wherein the rotational frequency is preferably estimated for this purpose at a maximum of the sum spectrum. The maximum can be determined e.g. by means of an iterative method and/or by means of a Taylor approximation in the sum spectrum.

It is further conceivable for the detection information to be provided in the form of acceleration values in at least one or two or three dimensions, preferably measured in the working machine. A frequency spectrum can be determined in each case from the acceleration values during the processing for the dimensions, and, where appropriate, an accumulation of the amplitudes of the frequency spectra of the different dimensions can be performed in order to transpose the frequency spectra into a single (one-dimensional) cumulative frequency spectrum. This accumulation of the amplitudes of all three coordinates can similarly serve as a noise-suppressing measure.

It can further advantageously be provided that an interpolation, in particular a trigonometric interpolation, is performed in the (cumulative) frequency spectrum in order to perform a or the identification of frequencies in the interpolated frequency spectrum. The interpolation can also be performed here e.g. by means of a zero padding or the like. This enables the rotational speed information to be reliably determined even from a small number of values.

In a further option, it can be provided that a fundamental frequency and integral multiples of the fundamental frequency of the detection information are detected and/or taken into account in a weighted and/or normalized manner, thus having the same amplitude, during the processing in order to determine the rotational speed information, preferably weighted according to predefined weightings in order to identify the fundamental frequency and to use the identified fundamental frequency as rotational speed information. It can be possible that the fundamental frequency and the integral multiples of the fundamental frequency, i.e. the frequencies of the harmonics, are initially identified in the identification of the frequencies and are identified, for example, as peak values, but the relevant frequency, in particular the fundamental frequency, cannot yet be identified. This means that it is not yet possible to distinguish in the identified frequencies whether the fundamental frequency or a harmonic or the like is involved. The or a calculation can thus be carried out to identify the frequencies in order to be able to infer specifically which of the identified frequencies is the fundamental frequency or is relevant to the rotational speed information.

The subject-matter of the invention similarly relates to a system for monitoring at least one working machine driven by a rotating, in particular electric, machine, having:
a monitoring device for detecting at least one item of detection information (in particular directly) in the working machine, wherein the at least one item of detection information is specific to an acceleration in the working machine, i.e., for example, for at least one mechanical oscillation in at least one direction,
a transmission device, in particular of the monitoring device, for transmitting the at least one item of detection information via a network to a central processing device, wherein the processing device is designed e.g. as a data processing system such as a central server,
the processing device to perform a (digital) processing of the transmitted detection information in order to determine rotational speed information for the monitoring which can be specific to a rotational speed of the rotating machine.

The system according to the invention thus offers the same advantages as those described in detail with reference to a method according to the invention. The system can further be suitable for carrying out a method according to the invention.

The subject-matter of the invention similarly relates to a computer program, in particular a computer program product, for monitoring at least one working machine driven by a rotating, in particular electric, machine, comprising commands which, during the execution of the computer program by a processing device, cause the latter to carry out the following steps, preferably successively or in any sequence, wherein the steps can correspond to the method steps of a method according to the invention:
receiving at least one item of detection information from a network, wherein the detection information is specific to an acceleration detected in the working machine and can have been detected in advance by a monitoring device in the working machine,
performing a processing of the received detection information in order to determine rotational speed information for the monitoring which can be specific to a rotational speed of the rotating machine.

The computer program according to the invention thus offers the same advantages as those described in detail with reference to a method and system according to the invention. The computer program can further be suitable for carrying out at least partially the method steps of a method according to the invention. The computer program can specifically be designed to carry out those method steps of the method according to the invention which are carried out by the processing device. A further computer program which is executed by the monitoring device can be provided if necessary for the further method steps.

Further advantages, features and details of the invention are set out in the following description in which exemplary embodiments of the invention are described in detail with reference to the drawings. The features mentioned in the claims and in the description can be essential to the invention individually in isolation or in any combination.

### BRIEF DESCRIPTION OF THE DRAWINGS

FIG. 1 shows a schematic view of a system according to an embodiment of the present invention.

FIG. 2 shows a schematic view to visualize a method according to an embodiment of the present invention.

FIG. 3 shows a schematic view of a detection of peak values in a frequency spectrum.

FIG. 4 shows a schematic view of a normalization of detected peak values in a frequency spectrum.

FIG. 5 shows a schematic view of a sum spectrum.

### DETAILED DESCRIPTION

Identical reference numbers are used in the following figures for the same technical features, even of different exemplary embodiments.

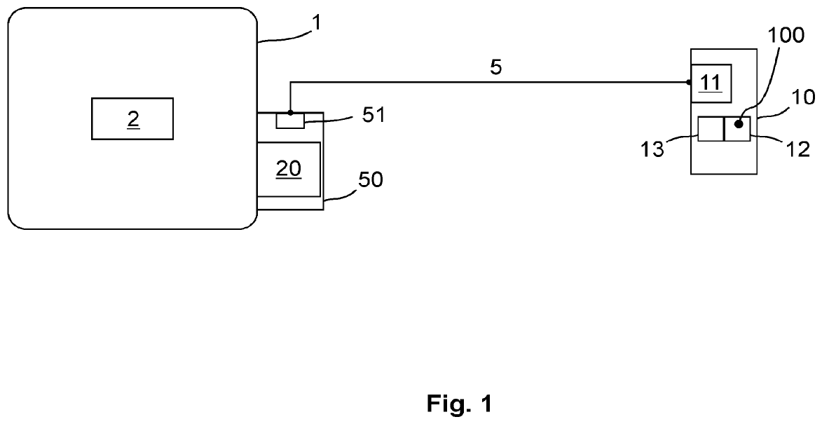

FIG. 1 shows a system for monitoring at least one working machine 1 driven by a rotating machine 2. The rotating machine 2 is designed, by way of example, as an electric machine 2, such as an electric motor 2. The working machine 1 shown is further designed, for example, in the form of a continuous-flow machine. In order to enable transportation of a medium, a rotational movement can be generated by the electric machine 2, said rotational movement in turn exciting oscillations in the working machine 1. The monitoring can correspondingly be intended to infer a state of the working machine 1 on the basis of the oscillation. For this purpose, a monitoring device 50 can be provided for detecting 110 at least one item of detection information 200 in the working machine 1. The monitoring device 50 can have a sensor system for this purpose in order to measure at least one acceleration on the working machine 1. The detection information 200 is therefore specific to the at least one acceleration in the working machine 1. It can be appropriate here to use at least one oscillation sensor 20 for the sensor system which can detect the accelerations in one or more directions. This enables the detection of one-dimensional or two-dimensional or three-dimensional detection information which then comprises information relating to the accelerations in the different direction(s). The detection of extensive information is conventionally necessary for reliable monitoring of the working machine 1, wherein said information cannot be evaluated in a cloud-based manner due to the data volume. According to the invention, however, the detection information 200 can have such a small data size that a transmission 120 to a central processing device 10 via a network 5 is possible. A transmission device 51 can be provided in the working machine 1 for this purpose. The processing device 10 is designed e.g. as a data processing system to perform a processing 130 of the transmitted detection information 200 in order to determine rotational speed information for the monitoring which is specific to a rotational speed of the electric machine 2. The processing device 10 can have a memory 12 for this purpose in which a computer program 100 is stored in non-volatile form and can be read and executed by a processor 13. A receive device 11 of the processing device 10 can further be provided in order to receive the at least one item of detection information 200 from the network 5.

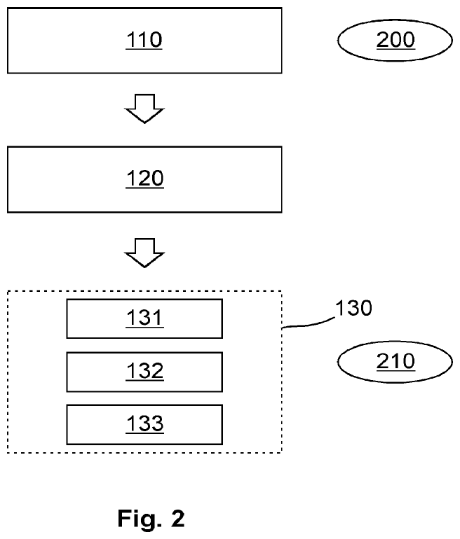

FIG. 2 shows the method steps of a method according to the invention for monitoring the working machine 1 with further details. According to a first method step, the at least one item of detection information 200 is detected 110 in the working machine 1. According to a second method step 120, the detection information 200 is then transmitted 120 via the network 5 to the central processing device 10. According to a third method step 130, the transmitted detection information 200 can then be processed 130 in order to determine the rotational speed information for the monitoring which is specific to the rotational speed of the electric machine 2. The processing 130 can be performed here as an oscillation analysis in order to determine the rotational speed information on the basis of a fundamental oscillation and further harmonics of the detection information 200 and, in particular to perform an estimation of the rotational speed. The following steps can further be carried out during the processing 130 in order to determine the rotational speed information:
performing a frequency analysis 131 of the detection information 200 in order to determine a frequency spectrum 210 of the detection information 200,
performing an identification 132 of a plurality of frequencies in the frequency spectrum 210, wherein the frequencies are assigned to a fundamental oscillation and at least a predefined number of harmonics of the detection information 200,
performing a calculation 133 on the basis of the identified frequencies, wherein the calculation is parameterized by the predefined number of harmonics.

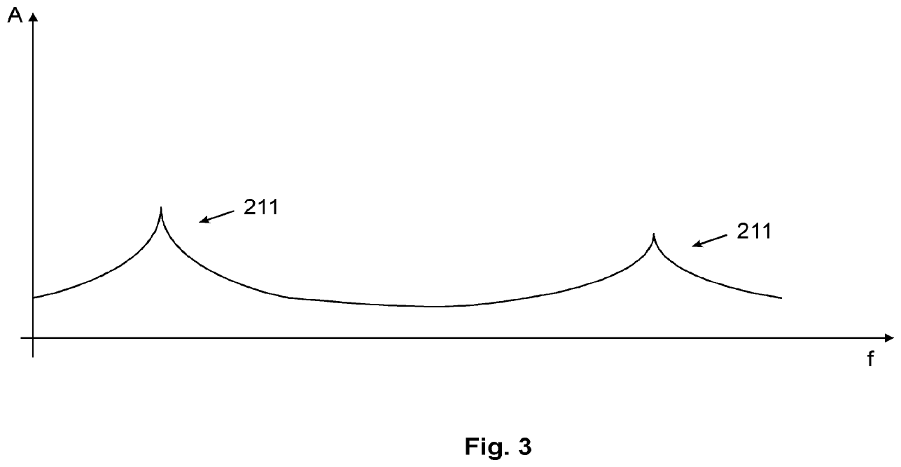

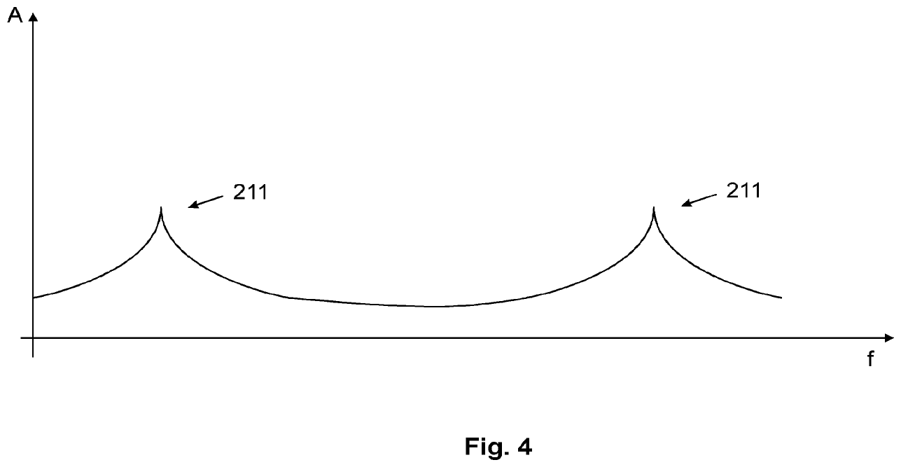

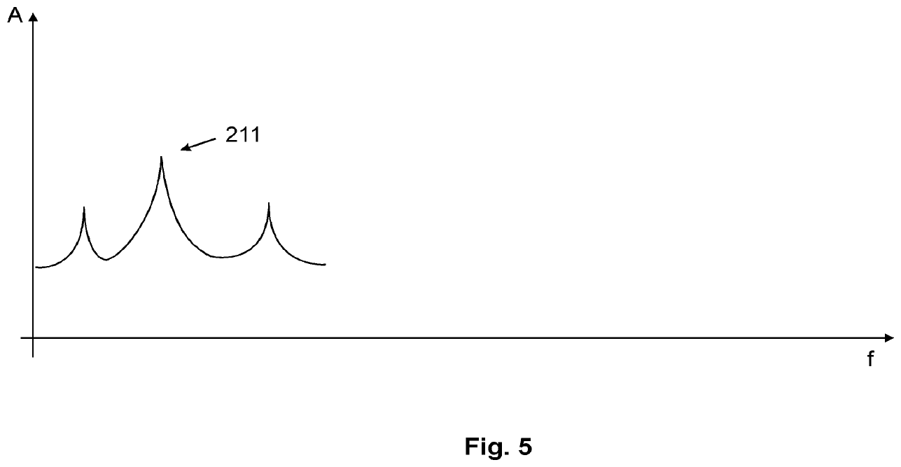

As shown by way of example in FIG. 3, performing the identification 132 can comprise detecting peak values 211 in the frequency spectrum 210 in order to identify the frequencies at the peak values 211. The frequency spectrum 210 is shown in FIGS. 3 to 5 with the amplitude A over the frequency f. It is evident that the peak values in FIG. 3 according to the continuous line have an amplitude A of differing height and are therefore not yet normalized. FIG. 4 shows that the identified peak values 211 in the frequency spectrum 210 can then be normalized for the further performance of the identification 132 in order to perform the subsequent calculation 133 on the basis of the normalized peak values 211. The peak values 211 are therefore set to the same amplitude. The subsequent calculation 133 can comprise the formation of a sum spectrum shown in FIG. 5, wherein an addition of the detected or localized frequencies, in particular the normalized peak values 211, is performed in a weighted manner. A frequency determination for determining the rotational speed information can then be performed on the basis of the sum spectrum, wherein the rotational frequency is estimated for this purpose at a maximum of the sum spectrum.

The processing 130 will be described below with further details. The following information, e.g. in the form of N measured samples with acceleration values in the three coordinates, is given by way of example as the detection information 200:

x,y,z∈ [symbol] .

N can denote the number of measured values and can, for example, be 2¹⁰ at a sampling rate of 4 kHz. The frequency analysis 131 can now be carried out for each of the three coordinates x, y and z, in each case as a one-dimensional, but possibly also as a two-dimensional or three-dimensional Fourier transform. A discrete Fourier transform will be carried out below by way of example for x as the frequency analysis 131 in order to obtain the associated frequency spectrum 210:

$$\hat{x} ∈ {ℝ}^{N} , {\hat{x}}_{l} = {\sum }_{0 \leq k < N} {x}_{k} \cdot {e}^{- 2 π i \frac{kl}{N}} , 0 \leq l < N .$$

This has the continuous continuation:

$$X ( b ) = {\sum }_{0 \leq k < N} {x}_{k} \cdot {e}^{- 2 π i \frac{kb}{N}} , b ∈ [ 0 , N [ ⊂ ℝ ,$$

which allows frequency components between the discrete bins l∈{0, 1 . . . , N−1} specified by the Fourier transform also to be calculated.

The interpolated result A can then be obtained by means of a trigonometric interpolation of a₁, wherein

$${{a}_{l} = {\vert {\hat{x}}_{l} \vert}^{2} + {\vert {\hat{y}}_{l} \vert}^{2} + \vert {\hat{z}}_{l} \vert}^{2} , 0 \leq l < \frac{N}{2} ,$$

i.e. can be obtained by accumulating the amplitudes of all three coordinates x, y and z. The trigonometric interpolation A can be calculated as follows:

A(b)=X(b)X̅(̅b̅)̅+Y(b)Y̅(̅b̅)̅+Z(b)Z̅(̅b̅)̅,b∈[0,N/2[⊂ [symbol] .

One possibility for implementing the interpolation is also a “zero padding” in the detection information 200. An example of a characteristic for A(b) is shown by the continuous line in FIG. 3. A high-pass filter can then optionally be applied to A(b), for example given by H(b)=A(b)−(A*l)(b), b∈[0,N/2⊂ [symbol] , where l(b) represents the filter core. In this way, the noise component A *l can be reduced and the peaks can be increased within the surrounding area.

A normalization of the relative peak heights can then take place for the identification 132. It can thereby be guaranteed that the harmonics are incorporated with the same weighting into the rotational speed estimation. This can be done by means of a calculation as follows:

P(b)=E(H;b),b∈[0,N/2[⊂

[symbol]

where E (H; b)=log(H(b)).

As an alternative to the indicated E, a different function can also be used which effects a peak normalization. P(b) is shown by way of example in FIG. 4.

The weighted sum spectrum can be determined for the subsequent calculation 133:

$$S ( b ) = {\sum }_{1 \leq k \leq {n}_{harms}} {w}_{k} \cdot P ( kb ) , b ∈ [ 0 , \frac{N}{2 {n}_{harms}} [ , w ∈ {ℝ}^{{n}_{harms}} .$$

Here, nₕₐᵣₘₛ denotes the number of harmonics to be taken into account and w denotes a suitable weighting which can be determined e.g. empirically and, by way of example, can also be 1. The number nₕₐᵣₘₛ can be e.g. in the range from 10 to 40, preferably 15 to 35. The sum spectrum is shown by way of example in FIG. 5.

The rotational speed or rotational frequency can then be estimated by means of a frequency determination, wherein the rotational frequency can be determined as the maximum in the sum spectrum

$${f}_{est} = arg {max}_{{f}_{min} \leq f \leq {f}_{max}} S ( \frac{f \cdot N}{{f}_{sample}} ) .$$

Here, fₛₐₘₚₗₑ can denote the sampling rate of the sensor, e.g. 4 kHz, and fₘᵢₙ and fₘₐₓ can denote predefined limits of the possible rotational speed range, such as e.g. fₘₐₓ=100/s and fₘᵢₙ=8/s.

As an example of an implementation of the rotational speed determination, in particular as a computer program, preferably by means of the formula arg

$${max}_{{f}_{min} \leq f \leq {f}_{max}} S ( \frac{f \cdot N}{{f}_{sample}} ) ,$$

a suitable equidistant discretization of the function S can be undertaken.

$${b}_{i} = \frac{i}{M} \cdot \frac{N}{2 \cdot {n}_{harms}} , 0 \leq i < M$$

The number M of discretization steps in the entire definition range of S should be chosen as proportional to N. An estimated value is defined as

$${\overline{f}}_{est} = arg {max}_{{f}_{min} \leq f \leq {f}_{max}} S ( \frac{{f}_{i} \cdot N}{{f}_{sample}} ) , {f}_{i} = \frac{{b}_{i} \cdot {f}_{sample}}{N} = \frac{i \cdot {f}_{sample}}{2 \cdot M \cdot {n}_{harms}} .$$

This can serve as an initial value f_{est,0}=\tilde{f}ₑₛₜ for an iterative method for determining the exact value fₑₛₜ. The calculation steps can be carried out for n=0, 1, . . . , and an exact calculation of the second-order Taylor approximation Tₙ of the first derivative of S can be performed at position f_{est,n}. The zero point f_{est,n+1} of Tₙ can then be calculated with a negative gradient. Alternatively, a Newton method can also be used for iterative determination of fₑₛₜ.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE NUMBER LIST

1 Working machine
2 Electric machine
5 Network
10 Processing device
11 Receive device
12 Memory
13 Processor
20 Oscillation sensor
50 Monitoring device
51 Transmission device
100 Computer program
110 Detection
120 Transmission
130 Processing
131 Frequency analysis
132 Identification
133 Calculation
200 Detection information
210 Frequency spectrum
211 Peak values
f Frequency
A Amplitude

1-15. (canceled)

16. A method for monitoring at least one working machine driven by a rotating machine, comprising the steps of:
detecting at least one item of detection information of the working machine which is specific to an acceleration in the working machine;
transmitting the detection information via a network to a central processing device;
processing the transmitted detection information to determine rotational speed information specific to a rotational speed of the rotating machine.

17. The method as claimed in claim 16, wherein
the detecting is performed by an oscillation sensor on the working machine configured to sense oscillations in three directions orthogonal to one another and generate the detection information in the form of three-dimensional acceleration values.

18. The method as claimed in claim 16, wherein
the network is configured at least partially to use a mobile radio network, the Internet, or the mobile radio network and the Internet, and
the detection information is generated by a plurality of working machines at different locations and transmitted to the processing device for central processing, and the processing step is performed for each of at least a portion of the plurality of working machines.

19. The method as claimed in claim 16, wherein
the processing is an oscillation analysis from which the rotational speed information is determined based on a fundamental oscillation and further harmonics of the detection information.

20. The method as claimed in claim 19, wherein
the fundamental oscillation is determined by an evaluation of the further harmonics.

21. The method as claimed in claim 16, wherein
the processing step includes
performing a frequency analysis of the detection information to determine a frequency spectrum of the detection information,
performing an identification of a plurality of frequencies in the frequency spectrum, wherein the identified plurality of frequencies are assigned to a fundamental oscillation, at least a predefined number of harmonics of the detection information, or both,
performing a calculation on the basis of the identified plurality of frequencies, wherein the calculation is parameterized by the predefined number of harmonics.

22. The method as claimed in claim 21, wherein
the performance of the identification of the frequencies includes
identifying peak values in the frequency spectrum, and
normalizing the identified peak values in the frequency spectrum the performance of the calculation is based on the normalized peak values.

23. The method as claimed in claim 22, wherein
the calculation includes generating a sum spectrum in which an addition of the normalized peak values of the identified plurality of frequencies is performed in a weighted manner.

24. The method as claimed in claim 23, wherein
the processing step includes performing a frequency determination on the basis of the sum spectrum in order to determine the rotational speed information, and
the rotational frequency is estimated at a maximum of the sum spectrum.

25. The method as claimed in claim 16, wherein
the detection information is in the form of acceleration values in at least one or two or three dimensions,
the processing step includes determining for each of the at least one or two or three dimensions the acceleration values, and
an accumulation of the amplitudes of a frequency spectra of the at least one or two or three dimensions is performed to generate from the frequency spectra a cumulative frequency spectrum.

26. The method as claimed in claim 23, wherein
the processing step includes an interpolation in the cumulative frequency spectrum and identifying frequencies in the interpolated frequency spectrum.

27. The method as claimed in one of the preceding claims, wherein
in the processing step a fundamental frequency and integral multiples of the fundamental frequency of the detection information are normalized and therefore taken into account having the same amplitude in order to determine the rotational speed information, weighted according to predefined weightings to identify the fundamental frequency and to use the identified fundamental frequency as rotational speed information.

28. A system for monitoring at least one working machine driven by a rotating machine, comprising:
a monitoring device configured to detect at least one item of detection information of the working machine which is specific to an acceleration in the working machine;
a transmission device configured to transmit the detection information via a network to a central processing device; and
a processing device configured to process the transmitted detection information and determine rotational speed information which is specific to a rotational speed of the rotating machine.

29. A non-transitory computer-readable medium containing a computer program configured to monitor at least one working machine driven by a rotating machine,
wherein the computer program comprises commands which, during the execution of the computer program by a processing device, cause the processing device to perform the steps of: latter to carry out at least the steps of:
receiving by the processing device at least one item of detection information from a network, the detection information being specific to an acceleration detected in the working machine,
processing by the processing device of the received detection information and determining rotational speed information which is specific to a rotational speed of the rotating machine.
